(19) United States
(12) Patent Application Publication
(10) Pub. No.: US 2013/0208008 A1
(43) Pub. Date: Aug. 15, 2013

(54) PROJECTOR AND PROJECTION IMAGE ADJUSTMENT METHOD

(71) Applicant: SEIKO EPSON CORPORATION, (US)

(72) Inventors: Atsushi OTERA, Shiojiri-shi (JP); Mamoru KOBAYASHI, Matsumoto-shi (JP)

(73) Assignee: SEIKO EPSON CORPORATION, TOKYO (JP)

(21) Appl. No.: 13/762,202

(22) Filed: Feb. 7, 2013

(30) Foreign Application Priority Data
Feb. 13, 2012 (JP) 2012-028099

(51) Int. Cl. G03B 21/14

(52) U.S. Cl. CPC G03B 21/142
USPC 345/634

(57) ABSTRACT

A projector used with another projector and capable of projecting an composite projection image includes an image processing section adapted to insert information of an adjusting projection image into information of a partial projection image to be a part of the composite projection image for a period shorter than one unit period for projecting the partial projection image, an imaging section adapted to take an image of the adjusting projection image, and a projection image adjustment section adapted to adjust the partial projection image based on the adjusting projection image taken by the imaging section.

The entire disclosure of Japanese Patent Application No.2012-028099, filed Feb. 13, 2012 is expressly incorporated by reference herein.

### BACKGROUND

1. Technical Field

The present invention relates to a projector and a projection image adjustment method.

2. Related Art

In the technological field of the projector, there is widely known that a plurality of projectors is provided to project a single projection image (hereinafter referred to as a composite projection image) by combining projection images (hereinafter referred to as partial projection images) from the respective projectors (e.g., image projection with tiling, and image projection with stacking). By adopting this configuration, it becomes possible to project a projection image (e.g., a projection image with an extremely large area, a projection image having a remarkably vertically-long or horizontally-long shape, and a projection image which can be viewed stereoscopically) difficult to realize with a single projector alone.

Incidentally, in order to project the composite projection image using a plurality of projectors, it is necessary to perform an image adjustment (e.g., an adjustment of a projection position, an adjustment of the luminance, a correction of the distortion condition) on each of the partial projection images. Although there is widely known the projector having a function of performing the image adjustment of the projection image, expert knowledge and skills are required for appropriately projecting the composite projection image by a manual operation. In other words, since there are a lot of items to be set and a lot of matters to be adjusted, it can be said that it is difficult for the user lacking the expert knowledge or skills to project the composite projection image using a plurality of projectors.

Therefore, in the past, there has been known a projector, which is used with another projector, and is capable of projecting the composite projection image as a whole, provided with a light modulation section for modulating light based on information of the partial projection image and information of an adjusting projection image, an image projection section for projecting the light from the light modulation section as the partial projection image and the adjusting projection image, an imaging section for taking the image of the adjusting projection image, and a projection image adjustment section for adjusting the partial projection image based on the adjusting projection image taken by the imaging section, and projecting the adjusting projection image prior to projecting the partial projection image to adjust the position, the luminance, the color, and so on of the partial projection image (see, e.g., JP-A-2004-336225).

According to the projector of the related art, by projecting the adjusting projection image in advance and performing the adjustment of the partial projection image, it becomes possible for the user lacking the expert knowledge or skills to project the composite projection image using a plurality of projectors.

However, in the projector of the related art, if the position, the luminance, the color, and so on of the partial projection image are shifted in the course of projecting the projection image by the projector, namely while the viewer is viewing the composite projection image, it is not achievable to perform the adjustment of the partial projection image while continuing the projection of the partial projection image. Therefore, it is necessary to inconveniently switch the entire image to be projected to the adjusting projection image in order to perform the adjustment of the partial projection image, and it is required to eliminate such inconvenience in the technological field of the projector.

### SUMMARY

An advantage of some aspects of the invention is to provide a projector, with which the partial projection image can be adjusted while continuing the projection of the partial projection image even in the case in which the position, the luminance, the color, and so on of the partial projection image are shifted while the viewer is viewing the projection image, and in which the inconvenience is eliminated compared to the projector of the related art. Further, the invention has an advantage of providing a projection image adjustment method capable of adjusting the partial projection image while continuing the projection of the partial projection image even in the case in which the position, the luminance, the color, and so on of the partial projection image are shifted while the viewer is viewing the projection image.

1. An aspect of the invention is directed to a projector used with another projector, and capable of projecting a projection image (hereinafter referred to as a composite projection image) in total, including an image processing section adapted to insert information of an adjusting projection image into information of a projection image (hereinafter referred to as a partial projection image) to be a part of the composite projection image for a period shorter than one unit period for projecting the partial projection image, a light modulation section adapted to modulate light based on the information of the partial projection image and the information of the adjusting projection image, an image projection section adapted to project light from the light modulation section as the partial projection image and the adjusting projection image, an imaging section adapted to take an image of the adjusting projection image, and a projection image adjustment section adapted to adjust the partial projection image based on the adjusting projection image taken by the imaging section.

According to the projector of this aspect of the invention, since there is provided the image processing section for inserting the information of the adjusting projection image into the information of the partial projection image for a period shorter than one unit period for projecting the partial projection image, there can be obtained a projector, with which the partial projection image can be adjusted while continuing the projection of the partial projection image even in the case in which the position, the luminance, the color, and so on of the partial projection image are shifted while the viewer is viewing the projection image, and in which the inconvenience is eliminated compared to the projector of the related art.

Further, according to the projector of this aspect of the invention, since the image processing section, the imaging section, and the projection image adjustment section are provided, by projecting the adjusting projection image in advance and performing the adjustment of the partial projection image, it becomes possible for the user lacking the expert knowledge or skills to project the composite projection image using a plurality of projectors similarly to the projectors of the related art.

It should be noted that since the image processing section inserts the information of the adjusting projection image into the information of the partial projection image for a period shorter than one unit period (so-called one frame) for projecting the partial projection image, the adjusting projection image becomes difficult to be recognized by the human eyes, and thus it is possible to project the projection image causing no uncomfortable feeling to the viewer.

It is also possible to arrange that the insertion of the adjusting projection image and the adjustment of the partial projection image are performed taking a human operation as a cue, or on a regular basis, or based on the human operation and the regular basis.

In the projector according to this aspect of the invention, it is preferable that a light modulation section having a light modulation device having a high response speed is used as the light modulation section. By adopting such a configuration, it becomes possible to promptly perform switching between the partial projection image and the adjusting projection image to thereby reduce or eliminate the uncomfortable feeling caused by inserting the adjusting projection image.

2. In the projector according to the above aspect of the invention, it is preferable that a timing synchronization section adapted to make the projector project the adjusting projection image in sync with timing at which the another projector projects an adjusting projection image.

By adopting such a configuration, since it results that the plurality of projectors projects the adjusting projection images and then performs the adjustment of the projection images at the same timing, it becomes possible to reduce the uncomfortable feeling with respect to the composite projection image caused in the viewer.

It should be noted that the timing synchronization section can also be arranged to make the projector project a blank image (a projection image in solid white or in solid black) in sync with the timing at which another projector projects the adjusting projection image. By adopting such a configuration, it becomes possible to prevent the adjusting projection images of the projectors from interfering with each other, and thus it becomes possible to perform the adjustment of the partial projection image with higher accuracy

It should be noted that the term “synchronize” in the present specification includes not only the case in which the timings completely coincide with each other but also the case in which the timings can be treated as substantially coinciding with each other even though some parts fail to temporally overlap each other.

3. In the projector according to the above aspects of the invention, it is preferable that timing at which the projector projects the adjusting projection image and timing at which the imaging section takes the image of the adjusting projection image are synchronized with each other.

By adopting such a configuration, it becomes possible to reduce the load of the imaging section, the projection image adjustment section, and so on compared to the case of always performing the imaging.

4. In the projector according to the above aspects of the invention, it is preferable that the image processing section uses an image different from the adjusting projection image, which is projected by the another projector, as the adjusting projection image.

By adopting such a configuration, it becomes possible to more accurately capture the state of the adjusting projection image projector by projector, and as a result, it becomes possible to perform the adjustment of the partial projection image with higher accuracy.

For example, the adjusting projection images different in pattern from each other and the adjusting projection images the same in pattern and different in color from each other are “different adjusting projection images.”

5. In the projector according to the above aspects of the invention, it is preferable that the composite projection image is formed of a plurality of the partial projection images having respective end portions overlapping each other, and the projection image adjustment section adjusts the partial projection image based on a result obtained by performing a correction due to comparison with configuration information of the adjusting projection image on the end portion of the adjusting projection image taken by the imaging section.

By adopting such a configuration, it becomes possible to prevent the adjustment accuracy from degrading even if the end portion of the adjusting projection image fails to be taken preferably due to the projection image of another projector.

It should be noted that although the image data of the adjusting projection image thus taken and the image data inserted by the image processing section are mainly used for “the comparison with the configuration information of the adjusting projection image,” the image data of the image (e.g., the adjusting projection image) projected by another projector, the position information of the projector, and so on can additionally be used.

6. In the projector according to the above aspects of the invention, it is preferable that the projection image adjustment section adjusts a projection position of the partial projection image and luminance of the partial projection image.

By adopting such a configuration, the projection position and the luminance, which concern the viewer the most, are adjusted, and thus, it becomes possible to project a more natural composite projection image.

It should be noted that it is obvious that the projection image adjustment section can also be arranged to adjust the color, the distortion condition of the projection image, and so on in addition to the projection position and the luminance.

7. In the projector according to the above aspects of the invention, it is preferable that the image processing section inserts the information of the adjusting projection image in accordance with a configuration of the partial projection image.

By adopting such a configuration, it is arranged that, for example, a dark adjusting projection image is projected when continuously projecting a dark partial projection image, and thus, it becomes possible to further reduce the uncomfortable feeling caused in the viewer.

8. In the projector according to the above aspects of the invention, it is preferable that the light modulation section has a micromirror light modulation device.

The micromirror light modulation device generally has a high response, and is capable of quickly switching the projection image. Therefore, by adopting such a configuration as described above, it becomes possible to promptly perform the switching between the partial projection image and the adjusting projection image to thereby reduce or eliminate the uncomfortable feeling caused by inserting the adjusting projection image.

9. Another aspect of the invention is directed to a projection image adjustment method adapted to adjust a projection image while continuing projection of a projection image (hereinafter referred to as a composite projection image) projected in total using a plurality of projectors, including projecting an adjusting projection image inserted in a projection image (hereinafter referred to as a partial projection image) to be a part of the composite projection image for a period shorter than one unit period for projecting the partial projection image, taking an image of the adjusting projection image, and adjusting the partial projection image based on the taken adjusting projection image.

According to the projection image adjustment method of this aspect of the invention, it becomes possible to adjust the partial projection image while continuing the projection of the partial projection image even in the case in which the position, the luminance, the color, and so on of the partial projection image are shifted while the viewer is viewing the projection image.

### BRIEF DESCRIPTION OF THE DRAWINGS

The invention will be described with reference to the accompanying drawings, wherein like numbers reference like elements.

FIGS. 1A and 1B are diagrams shown for explaining projectors according to a first embodiment of the invention.

FIG. 2 is a functional block diagram of the projector according to the first embodiment.

FIG. 3 is a timing chart of projection images in the projectors according to the first embodiment.

FIGS. 4A and 4B are diagrams shown for explaining adjusting projection images in the first embodiment.

FIG. 5 is a step chart of a projection image adjustment method according to the first embodiment.

FIG. 6 is a timing chart of projection images in projectors according to a second embodiment.

FIG. 7 is a timing chart of projection images in projectors according to a third embodiment.

### DESCRIPTION OF EXEMPLARY EMBODIMENTS

Hereinafter, a projector and a projection image adjustment method according to the invention will be explained based on some embodiments shown in the accompanying drawings.

### First Embodiment

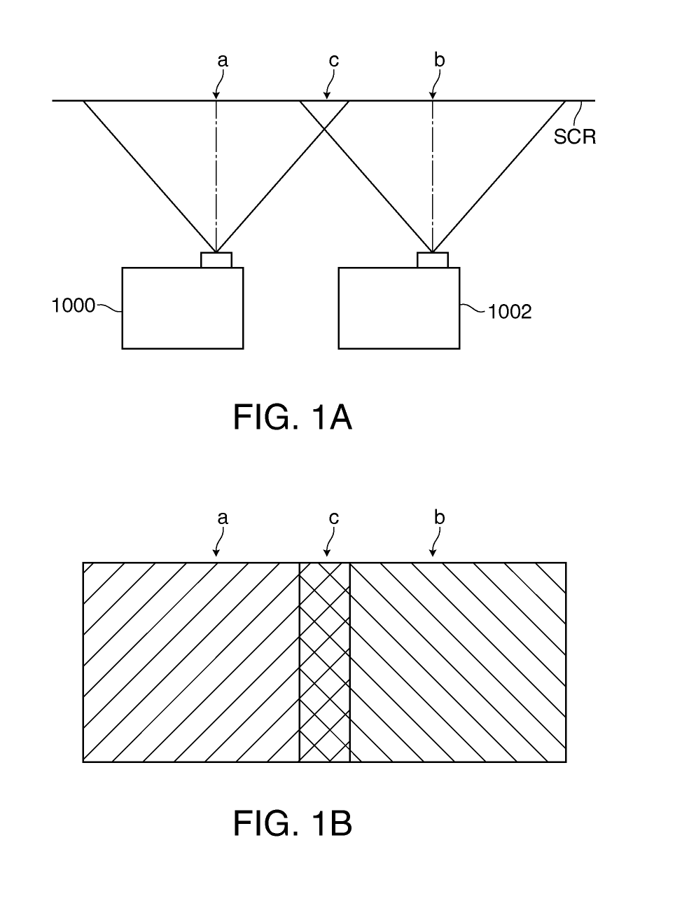

FIGS. 1A and 1B are diagrams shown for explaining the projectors 1000, 1002 according to a first embodiment of the invention. FIG. 1A is a schematic top view of the projectors 1000, 1002 for projecting a composite projection image, and FIG. 1B is a diagram shown for explaining projection images to be projected on a screen SCR.

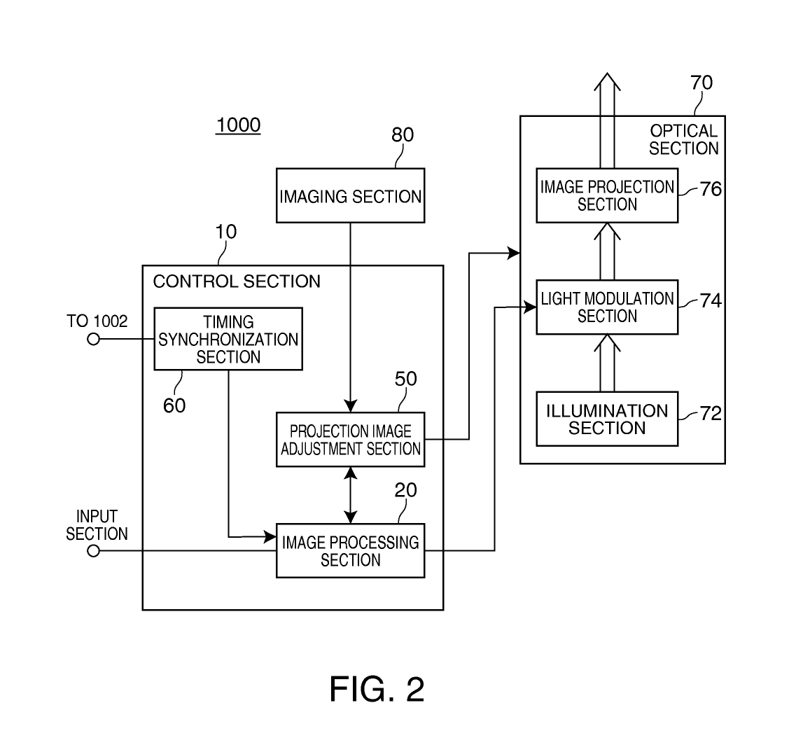

FIG. 2 is a functional block diagram of the projector 1000 according to the first embodiment. It should be noted that the arrows shown in FIG. 2 are for schematically showing the flow of light in an optical section 70, or for schematically showing the flow of information in other places.

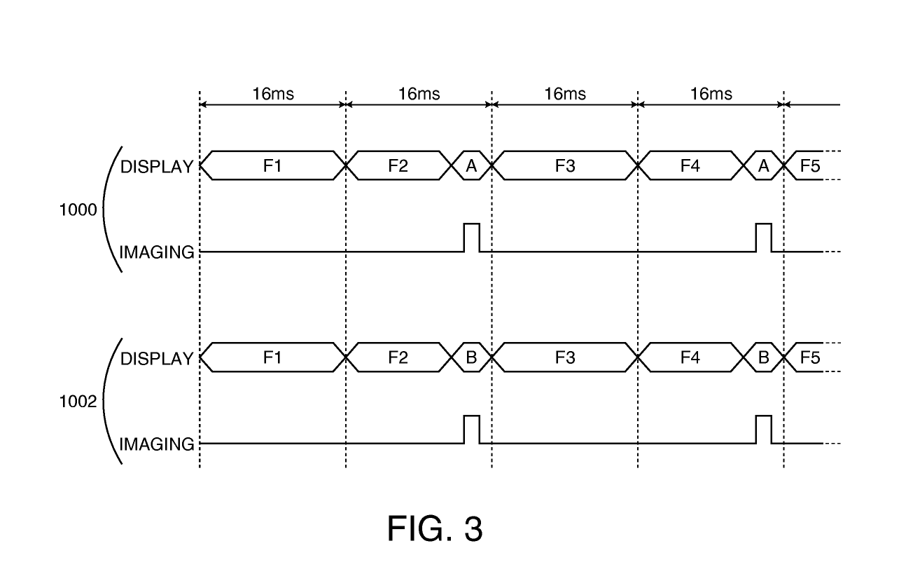

FIG. 3 is a timing chart of the projection images in the projectors 1000, 1002 according to the first embodiment. It should be noted that the symbol A denotes that the projector 1000 projects the adjusting projection image, and the symbol B denotes that the projector 1002 projects the adjusting projection image.

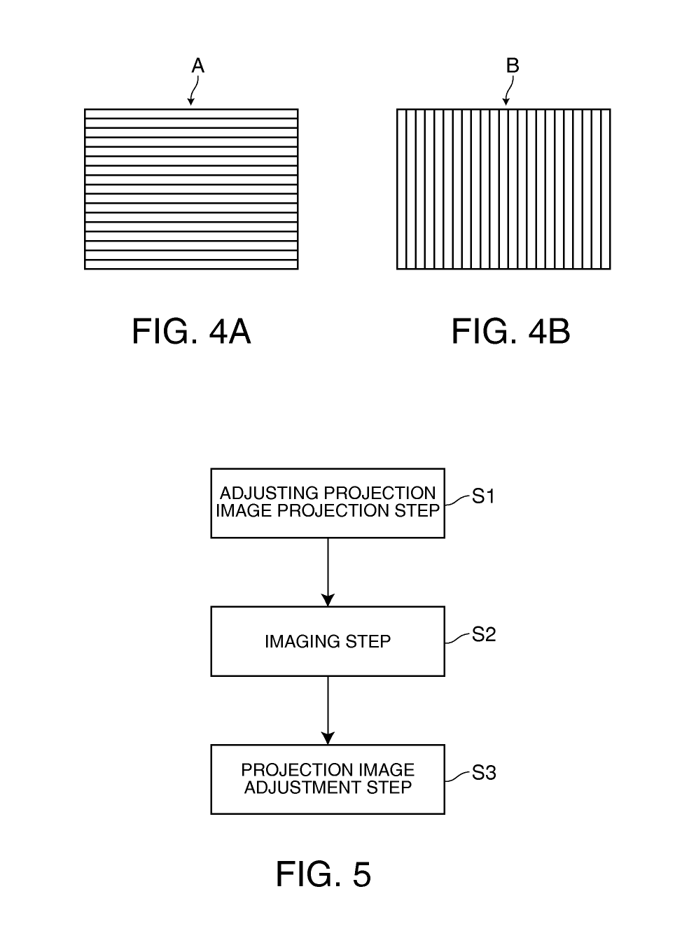

FIGS. 4A and 4B are diagrams shown for explaining the adjusting projection images in the first embodiment. FIG. 4A shows an example of the adjusting projection image projected by the projector 1000, and FIG. 4B shows an example of the adjusting projection image projected by the projector 1002.

FIG. 5 is a step chart of a projection image adjustment method according to the first embodiment.

As shown in FIGS. 1A and 1B, the projectors 1000, 1002 according to the first embodiment are each a projector used with another projector, and capable of projecting a composite projection image. The projectors 1000, 1002 perform so-called tiling to project the composite projection image on the screen SCR. In FIG. 1B, the region where the partial projection image of the projector 1000 is projected is denoted with the symbol “a,” the region where the partial projection image of the projector 1002 is projected is denoted with the symbol “b,” and the region where the partial projection image by the projector 1000 and the partial projection image by the projector 1002 overlap each other is denoted with the symbol “c.” In other words, in the first embodiment, the composite projection image is composed of a plurality of partial projection images having the respective end portions overlapping each other.

Then, the configuration of the projector 1000 will be explained. It should be noted that since the projector 1002 has substantially the same configuration as that of the projector 1000, the graphical description and the explanation thereof will be omitted.

As shown in FIG. 2, the projector 1000 is provided with a control section 10, the optical section 70, and the imaging section 80.

The function of the projector 1000 is exerted by the functions of the functional blocks explained hereinafter.

The partial projection image from the projector 1000 is projected in a time-divisional manner (e.g., at 60 Hz). Assuming that one unit of the partial projection image projected in a time-divisional manner is a unit partial projection image (see F1 through F5 in FIG. 3), the projector 1000 projects the adjusting projection image (see FIG. 4A) within the region (see the symbol “a” in FIGS. 1A and 1B) in which the partial projection image is projected, after projecting a certain unit partial projection image and before projecting the subsequent unit partial projection image (between F2 and F3 and between F4 and F5 in FIG. 3). In other words, the projector 1000 projects the adjusting projection image while inserting the adjusting projection image into the partial projection image for a period shorter than one unit period for projecting the partial projection image. It should be noted that the period for projecting the adjusting projection image is a period (e.g., several milliseconds) shorter than one unit period for projecting the partial projection image. Further, it is also possible to arrange that the adjusting projection image is inserted therein taking the projection for every colored light instead of the projection for every frame, and is then projected.

The timing at which the projector 1000 projects the adjusting projection image is synchronized with the timing at which another projector (the projector 1002) projects the adjusting projection image (see FIG. 3).

Further, in the projector 1000, the timing at which the projector 1000 projects the adjusting projection image and the timing at which the imaging section 80 takes the image of the adjusting projection image are synchronized with each other.

As shown in FIGS. 4A and 4B, the projector 1000 projects an adjusting projection image (e.g., a horizontally-striped pattern; see the symbol A shown in FIG. 4A) different from an adjusting projection image (e.g., a vertically-striped pattern; see the symbol B shown in FIG. 4B) projected by another projector (the projector 1002) as the adjusting projection image. It should be noted that the adjusting projection images shown here are only for illustrative purposes, and other adjusting projection images than the above can also be used.

Then, individual functional elements will be explained.

The control section 10 is provided with an image processing section 20, a projection image adjustment section 50, and a timing synchronization section 60. The control section 10 is composed of constituents such as various circuits, various storage devices, and a CPU, and controls the overall function of the projector 1000. The control section 10 inserts the information of the adjusting projection image into the information of the partial projection image for a period shorter than one unit period for projecting the partial projection image, and then transmits the information of the partial projection image and the information of the adjusting projection image to the optical section 70 due to the function of the functional elements provided to the control section 10.

It should be noted that the elements displayed in the control section 10 of the first embodiment are the elements necessary for explaining the invention, and the control section 10 can further be provided with elements other than the elements described above. Further, each of the elements can be arranged to be independently provided outside the control section 10.

The image processing section 20 inserts the information of the adjusting projection image into the information of the partial projection image for a period shorter than one unit period for projecting the partial projection image. Further, the image processing section 20 generates the information of the adjusting projection image, and further processes the image information input from the outside to thereby generate the information of the partial projection image. The image information from the outside is input from an input section (e.g., an A/D converter). Further, the image processing section 20 inserts the adjusting projection image different from the adjusting projection image projected by another projector (the projector 1002) as the adjusting projection image (see FIG. 4A). The information from the image processing section 20 is transmitted to a light modulation section 74 of the optical section 70. The image processing section 20 is composed of constituents such as a recording device, an image processing circuit, a RAM, and a CPU.

In the first embodiment, the image processing section 20 inserts the information of the adjusting projection image into the information of the partial projection image at a rate of once at every two frames of the partial projection image (see FIG. 3). The image processing section 20 can be arranged to insert the information of the adjusting projection image into the information of the partial projection image at another rate (e.g., once at every 60 frames, or once at every 600 frames), or can be arranged to insert the information of the adjusting projection image into the information of the partial projection image taking an operation by a human as a cue.

It should be noted that it can be arranged that the constituents other than the image processing section perform the generation of the information of the adjusting projection image, and the generation of the information of the partial projection image by processing the image information input externally.

It is also possible to obtain the information of the adjusting projection image by retrieving the information recorded on a recording medium instead of generating the information.

The projection image adjustment section 50 adjusts the partial projection image based on the adjusting projection image taken by the imaging section 80.

In the first embodiment, since the composite projection image is composed of a plurality of partial projection images having the respective end portions overlapping each other, the end portion of the adjusting projection image overlaps the projection image of the projector 1002 (see the symbol “c” shown in FIG. 1B). Therefore, the projection image adjustment section 50 adjusts the partial projection image based on the result obtained by performing the correction due to the comparison with the configuration information of the adjusting projection image on the end portion of the adjusting projection image taken by the imaging section 80.

The projection image adjustment section 50 mainly adjusts the projection position of the partial projection image and the luminance of the partial projection image. Besides the above, it is possible to arrange that the distortion condition and the chromaticness of the partial projection image are also adjusted. The projection image adjustment section 50 is composed of constituents such as a recording device, an image processing circuit, a RAM, and a CPU.

The timing synchronization section 60 makes the projector project the adjusting projection image in sync with the timing at which another projector (the projector 1002) projects the adjusting projection image (see FIG. 3). The timing synchronization section 60 is connected to the projector 1002 via a variety of types of terminals and so on.

It should be noted that although it is assumed in the first embodiment that the unit partial projection images (frames) of the projectors 1000, 1002 are also synchronized with each other, the invention is not limited thereto. In the configuration of the first embodiment, it is sufficient that the timing at which the adjusting projection image A is projected and the timing at which the adjusting projection image B is projected are synchronized with each other, and it is not required that, for example, the unit partial projection images are synchronized with each other.

The optical section 70 is an element in charge of the control of the light inside the projector 1000. The optical section 70 is provided with an illumination section 72, the light modulation section 74, and an image projection section 76. Each of the elements is typical and used widely, and the detailed explanation therefor except the part related to the invention will be omitted.

The illumination section 72 has a light source, and emits light.

The light modulation device 74 modulates the light from the illumination section 72 based on the information of the partial projection image and the information of the adjusting projection image. The light modulation section 74 has a micromirror light modulation device, and modulates the light by controlling the states of a number of micromirrors to switch the reflection of the light. As the micromirror light modulation device, for example, a digital micromirror device (DMD, a trademark of Texas Instruments) can be used. Such a light modulation device as described above is fast in response speed, and can preferably be used for the projector according to the invention. It should be noted that it is also possible to use a liquid crystal light modulation device for modulating the light using the combination of a liquid crystal panel and polarization plates, as the light modulation section.

The image projection section 76 projects the light from the light modulation section 74 on the screen SCR as the partial projection image and the adjusting projection image. The image projection section 76 is formed of, for example, a projection lens.

The imaging section 80 takes the image of the adjusting projection image. The imaging can be performed using, for example, a variety of sensors (e.g., a CCD image sensor). In the projector 1000, the timing at which the image projection section projects the adjusting projection image and the timing at which the imaging section takes the image of the adjusting projection image are synchronized with each other (see FIG. 3).

It should be noted that the constituents exemplified in the respective sections are capable of communicating information via a system bus and so on.

Each of these sections can be realized partially or entirely by hardware such as a circuit, or software such as a driver.

Then, a projection image adjustment method according to the first embodiment will be explained.

The projection image adjustment method according to the first embodiment is a projection image adjustment method for adjusting the projection image while continuing the projection of the composite projection image in the case of projecting the composite projection image using a plurality of projectors (the projectors 1000, 1002), and includes an adjusting projection image projection step S1, an imaging step S2, and a projection image adjustment step S3 in this order as shown in FIG. 5.

The adjusting projection image projection step S1 is a step of projecting the adjusting projection image while inserting the adjusting projection image into the partial projection image for a period shorter than one unit period for projecting the partial projection image. The step is executed by the image processing section 20 of the control section 10 and the optical section 70.

The imaging step S2 is a step of taking the image of the adjusting projection image. The step is executed by the imaging section 80.

The projection image adjustment step S3 is a step of adjusting the partial projection image based on the adjusting projection image thus taken. The step is executed by the projection image adjustment section 50 of the control section 10.

Then, advantages of the projectors 1000, 1002 and the projection image adjustment method according to the first embodiment will be explained.

According to the projectors 1000, 1002 related to the first embodiment, since there is provided the image processing section 20, there can be obtained a projector, with which the partial projection image can be adjusted while continuing the projection of the partial projection image even in the case in which the position, the luminance, the color, and so on of the partial projection image are shifted while the viewer is viewing the projection image, and in which the inconvenience is eliminated compared to the projector of the related art.

Further, according to the projectors 1000, 1002 related to the first embodiment, since the image processing section 20, the imaging section 80, and the projection image adjustment section 50 are provided, by projecting the adjusting projection image in advance and performing the adjustment of the partial projection image, it becomes possible for the user lacking the expert knowledge or skills to project the composite projection image using a plurality of projectors similarly to the projectors of the related art.

Further, according to the projectors 1000, 1002 related to the first embodiment, since the image processing section 20 inserts the information of the adjusting projection image into the information of the partial projection image for a period shorter than one unit period (so-called one frame) for projecting the partial projection image, the adjusting projection image becomes difficult to be recognized by the human eyes, and thus it is possible to project the projection image causing no uncomfortable feeling to the viewer.

Further, according to the projectors 1000, 1002 related to the first embodiment, since the light modulation section 74 having the light modulation device with a high response speed is used as the light modulation section, it becomes possible to promptly switch between the partial projection image and the adjusting projection image to thereby reduce or eliminate the uncomfortable feeling caused by inserting the adjusting projection image.

Further, according to the projectors 1000, 1002 related to the first embodiment, since the timing synchronization section 60 is provided, it results that a plurality of projectors projects the adjusting projection image at the same timing to perform the adjustment of the projection image, and therefore, it becomes possible to reduce the uncomfortable feeling with respect to the composite projection image caused in the viewer.

Further, according to the projectors 1000, 1002 related to the first embodiment, since the timing at which the projectors 1000, 1002 project the adjusting projection images and the timing at which the imaging section 80 takes the image of the adjusting projection image are synchronized with each other, it becomes possible to reduce the load of the imaging section 80 and the projection image adjustment section 50 compared to the case of always performing the imaging.

Further, according to the projectors 1000, 1002 related to the first embodiment, since the image processing section 20 inserts the adjusting projection image, which is different from the adjusting projection image projected by another projector, as the adjusting projection image, it becomes possible to more accurately capture the state of the adjusting projection image projector by projector, and as a result, it becomes possible to perform the adjustment of the partial projection image with higher accuracy.

Further, according to the projectors 1000, 1002 related to the first embodiment, since the projection image adjustment section 50 adjusts the partial projection image based on the result obtained by performing the correction due to the comparison with the configuration information of the adjusting projection image on the end portion of the adjusting projection image taken by the imaging section 80, it becomes possible to suppress the degradation of the adjustment accuracy even if the end portion of the adjusting projection image fails to be imaged preferably due to the projection image of another projector.

Further, according to the projectors 1000, 1002 related to the first embodiment, since the projection image adjustment section 50 adjusts the projection position of the partial projection image and the luminance of the partial projection image, it becomes possible to adjust the projection position and the luminance, which concern the viewer the most, to thereby project a more natural composite projection image.

Further, according to the projectors 1000, 1002 related to the first embodiment, since the light modulation section 74 has the micromirror light modulation device, it becomes possible to promptly switch between the partial projection image and the adjusting projection image to thereby reduce or eliminate the uncomfortable feeling caused by inserting the adjusting projection image.

According to the projection image adjustment method related to the first embodiment, since the adjusting projection image projection step S1, the imaging step S2, and the projection image adjustment step S3 are included in this order, it becomes possible to perform the adjustment of the partial projection image while continuing the projection of the partial projection image even in the case in which the position, the luminance, the color, and so on of the partial projection image are shifted while the viewer is viewing the projection image.

### Second Embodiment

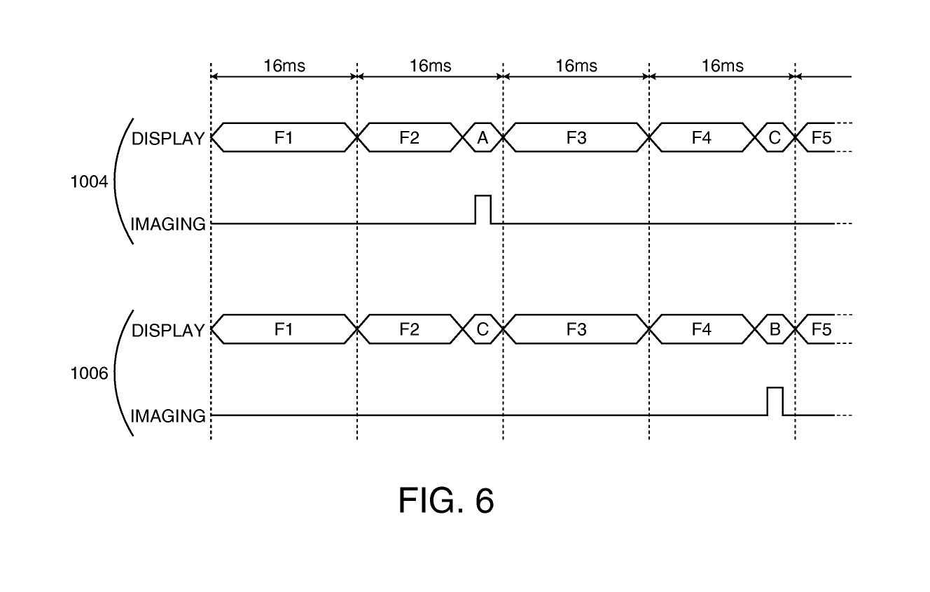

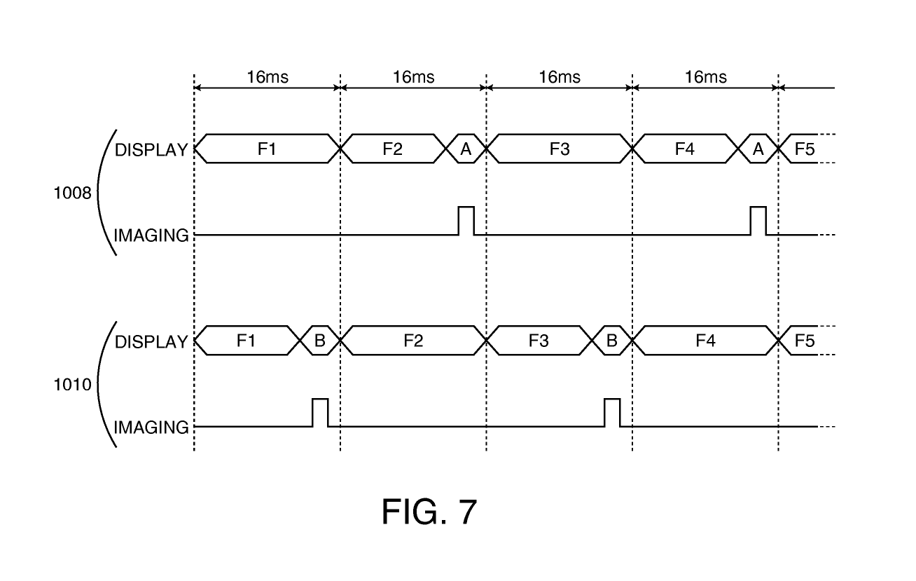

FIG. 6 is a timing chart of the projection images in projectors 1004, 1006 according to a second embodiment. It should be noted that the symbol C denotes that a blank image in solid black is projected (no projection image is projected).

The projectors 1004, 1006 (not shown) according to the second embodiment basically have a configuration substantially the same as that of the projectors 1000, 1002 according to the first embodiment, but are different from the projectors 1000, 1002 according to the first embodiment in the timing at which the adjusting projection image is projected. Specifically, as shown in FIG. 6, the projector 1004 according to the second embodiment projects the blank image in solid black when the projector 1006 projects the adjusting projection image B (see the period between F4 and F5 in FIG. 6), and the projector 1006 projects the blank image in solid black when the projector 1004 projects the adjusting projection image A (see the period between F2 and F3 in FIG. 6).

Therefore, it becomes possible to prevent the adjusting projection images of the projectors from interfering with each other, and thus it becomes possible to perform the adjustment of the partial projection image with higher accuracy.

It should be noted that since the configuration of the projectors 1004, 1006 itself according to the second embodiment is the same as that of the projectors 1000, 1002 according to the first embodiment, the graphical description and the explanation thereof will be omitted.

It should be noted that although it is assumed in the second embodiment that the unit partial projection images (frames) of the projectors 1004, 1006 are also synchronized with each other, the invention is not limited thereto. In the configuration of the second embodiment, it is sufficient that the timing at which the adjusting projection image A or the adjusting projection image B is projected and the timing at which the blank image C is projected are synchronized with each other, and it is not required that, for example, the unit partial projection images are synchronized with each other.

As described above, although the projectors 1004, 1006 according to the second embodiment are different from the projectors 1000, 1002 according to the first embodiment in the timing of projecting the adjusting projection image, since there is provided the image processing section 20 for inserting the information of the adjusting projection image into the information of the partial projection image for a period shorter than one unit period for projecting the partial projection image, it is possible to perform the adjustment of the partial projection image while continuing the projection of the partial projection image even in the case in which the position, the luminance, the color, and so on of the partial projection image are shifted while the viewer is viewing the projection image similarly to the projectors 1000, 1002 according to the first embodiment, and therefore, there are obtained the projectors in which the inconvenience is eliminated compared with the projector in the related art.

It should be noted that the projectors 1004, 1006 according to the second embodiment have substantially the same configuration as that of the projectors 1000, 1002 according to the first embodiment except the point that the timing of projecting the adjusting projection image is different from that in the projectors 1000, 1002 according to the first embodiment, and therefore, have the corresponding advantages out of the advantages the projectors 1000, 1002 according to the first embodiment have without change.

### Third Embodiment

FIG. 7 is a timing chart of the projection images in projectors 1008, 1010 according to a third embodiment.

The projectors 1008, 1010 (not shown) according to the third embodiment basically have a configuration substantially the same as that of the projectors 1000, 1002 according to the first embodiment, but are different from the projectors 1000, 1002 according to the first embodiment in the timing at which the adjusting projection image is projected. Specifically, as shown in FIG. 7, in the projectors 1008, 1010 according to the third embodiment, the timing at which the projector 1008 projects the adjusting projection image is not synchronized with the timing at which another projector (the projector 1010) projects the adjusting projection image.

In this case, the end portion of the adjusting projection image projected by the projector 1008 overlaps the end portion of the partial projection image projected by the projector 1010 (vice versa). However, since the projection image adjustment section 50 adjusts the partial projection image based on the result obtained by performing the correction due to the comparison with the configuration information of the adjusting projection image on the end portion of the adjusting projection image taken by the imaging section 80, it becomes possible to perform appropriate adjustment even in such a case.

It should be noted that since the configuration of the projectors 1008, 1010 itself according to the third embodiment is the same as that of the projectors 1000, 1002 according to the first embodiment, the graphical description and the explanation thereof will be omitted. It should be noted that in the third embodiment, since the timing of projecting the adjusting projection image in the projector 1008 and the timing of projecting the adjusting projection image in the projector 1010 are not synchronized with each other, it is also possible for the projectors 1008, 1010 not to be provided with the timing synchronization section.

It should be noted that although it is assumed in the third embodiment that the unit partial projection images (frames) of the projectors 1008, 1010 are synchronized with each other, the invention is not limited thereto. In the configuration of the third embodiment, it is not required for the unit partial projection image to be synchronized with each other.

As described above, although the projectors 1008, 1010 according to the third embodiment are different from the projectors 1000, 1002 according to the first embodiment in the timing of projecting the adjusting projection image, since there is provided the image processing section 20 for inserting the information of the adjusting projection image into the information of the partial projection image for a period shorter than one unit period for projecting the partial projection image, it is possible to perform the adjustment of the partial projection image while continuing the projection of the partial projection image even in the case in which the position, the luminance, the color, and so on of the partial projection image are shifted while the viewer is viewing the projection image similarly to the projectors 1000, 1002 according to the first embodiment, and therefore, there are obtained the projectors in which the inconvenience is eliminated compared with the projector in the related art.

It should be noted that the projectors 1008, 1010 according to the third embodiment have substantially the same configuration as that of the projectors 1000, 1002 according to the first embodiment except the point that the timing of projecting the adjusting projection image is different from that in the projectors 1000, 1002 according to the first embodiment, and therefore, have the corresponding advantages out of the advantages the projectors 1000, 1002 according to the first embodiment have without change.

Although the invention is explained hereinabove based on the embodiments described above, the invention is not limited to the embodiments described above. The invention can be put into practice in various forms within the scope or the spirit of the invention, and the following modifications, for example, are also possible.

1. The number, the configuration, the type, and so on of each of the constituents described in each of the embodiments are only for illustrative purposes, and can be modified within the range in which the advantages of the invention are preserved.

2. Although in each of the embodiments described above the invention is explained taking the case in which the composite projection image is projected using the two projectors as an example, the invention is not limited thereto. For example, it is also possible to project the composite projection image using three or more projectors.

3. Although in each of the embodiments described above the invention is explained taking the case in which the composite projection image is projected by so-called tiling as an example, the invention is not limited thereto. For example, the composite projection image can also be projected by so-called stacking

4. In the projectors according to the invention, the image processing section can also insert the information of the adjusting projection image in accordance with the configuration of the partial projection image. By adopting such a configuration, it is arranged that, for example, a dark adjusting projection image is projected when continuously projecting a dark partial projection image, and thus, it becomes possible to further reduce the uncomfortable feeling caused in the viewer.

What is claimed is:

1. A projector used with another projector, and capable of projecting a projection image (hereinafter referred to as a composite projection image) in total, comprising:
an image processing section adapted to insert information of an adjusting projection image into information of a projection image (hereinafter referred to as a partial projection image) to be a part of the composite projection image for a period shorter than one unit period for projecting the partial projection image;
a light modulation section adapted to modulate light based on the information of the partial projection image and the information of the adjusting projection image;
an image projection section adapted to project light from the light modulation section as the partial projection image and the adjusting projection image;
an imaging section adapted to take an image of the adjusting projection image; and
a projection image adjustment section adapted to adjust the partial projection image based on the adjusting projection image taken by the imaging section.

2. The projector according to claim 1, further comprising:
a timing synchronization section adapted to make the projector project the adjusting projection image in sync with timing at which the another projector projects an adjusting projection image.

3. The projector according to claim 1, wherein
timing at which the projector projects the adjusting projection image and timing at which the imaging section takes the image of the adjusting projection image are synchronized with each other.

4. The projector according to claim 1, wherein
the image processing section uses an image different from the adjusting projection image, which is projected by the another projector, as the adjusting projection image.

5. The projector according to claim 1, wherein
the composite projection image is formed of a plurality of the partial projection images having respective end portions overlapping each other, and
the projection image adjustment section adjusts the partial projection image based on a result obtained by performing a correction due to comparison with configuration information of the adjusting projection image on the end portion of the adjusting projection image taken by the imaging section.

6. The projector according to claim 1, wherein
the projection image adjustment section adjusts a projection position of the partial projection image and luminance of the partial projection image.

7. The projector according to claim 1, wherein
the image processing section inserts the information of the adjusting projection image in accordance with a configuration of the partial projection image.

8. The projector according to claim 1, wherein
the light modulation section has a micromirror light modulation device.

9. A projection image adjustment method adapted to adjust a projection image while continuing projection of a projection image (hereinafter referred to as a composite projection image) projected in total using a plurality of projectors, the method comprising:
projecting an adjusting projection image inserted in a projection image (hereinafter referred to as a partial projection image) to be a part of the composite projection image for a period shorter than one unit period for projecting the partial projection image;
taking an image of the adjusting projection image; and
adjusting the partial projection image based on the taken adjusting projection image.
